(19) United States
(12) Patent Application Publication
(10) Pub. No.: US 2018/0285916 A1
(43) Pub. Date: Oct. 4, 2018

(54) VIRTUAL PAYMENT REWARD REDEMPTION SYSTEMS AND METHODS

(71) Applicant: Bridge2 Solutions, LLC, Alpharetta, GA (US)

(72) Inventors: Andrew Althauser, Alpharetta, GA (US); Ravi Venkatesan, Alphareta, GA (US); Larry Wine, Alpharetta, GA (US); Craig McLaughlin, Alpharetta, GA (US); Jason Phillips, Alpharetta, GA (US); Jerry Bulger, Alpharetta, GA (US)

(21) Appl. No.: 15/942,714

(22) Filed: Apr. 2, 2018

Related U.S. Application Data
(60) Provisional application No. 62/479,595, filed on Mar. 31, 2017.

(51) Int. Cl. G06Q 30/02; G06Q 20/36

(52) U.S. Cl. CPC G06Q 30/0233; G06Q 20/322; G06Q 20/363

(57) ABSTRACT

A system including: at least one processor; and at least one memory having stored thereon computer program code that, when executed by the at least one processor, instructs the at least one processor to: retrieve, from an account host, an account credit amount associated with a user account; convert the credit amount to a monetary value based on one or more conversion rules associated with the account host; and provide an available balance of a virtual rewards account to correspond to the monetary value.

### CROSS-REFERENCE TO RELATED APPLICATION

This application claims the benefit under 35 U.S.C. § 119(e) of U.S. Provisional Patent Application No. 62/479,595, filed 31 Mar. 2017, of which the entire contents and substance are hereby incorporated by reference as if fully set forth below.

### FIELD

The present disclosure relates generally to the redemption of earned credit (including points, credits, miles and other forms of rewards currency), and more particularly, the redemption of earned credits through a virtual payment vehicle.

### BACKGROUND

In order to engender customer loyalty, many merchants (e.g., stores, hotels, airlines) and service providers (e.g., credit card companies) provide customers reward credits (referred to as “points” throughout this document) for purchases or product uses. For example, a credit card company may give a customer one point for each dollar spent using the credit card. In the related art, customers may redeem the awarded points in exchange for a credit (e.g., a credit card statement credit), or exchange the points for a gift card or select items through a dedicated website. However, such related art systems do not allow easy or fast redemption of credits directly at stores, websites and apps, limiting their appeal to customers, and thus limiting their value as a loyalty initiative.

Accordingly, there is a need for systems and methods that improve upon reward redemption. For example, recent advances in technology have enabled redemption of loyalty currency in-store at a Point of Sale (“POS”), but related art solutions often require either a change to the POS interface software or users to perform multiple steps, for example, creating prepaid payment network cards or variable denomination closed loop electronic gift cards. Some implementations of this technology will make the redemption of loyalty currency easy and automated throughout the omnichannel retail world. In certain embodiments, a virtual payment vehicle (e.g., a virtual rewards card, or “VRC”) may be created, be linked to a rewards account, inserted into a virtual wallet, and used to make purchases in real-time. According to some implementation, these purchases may be made without necessitating POS software changes and providing a simpler and more efficient user experience.

### SUMMARY

In some embodiments there is provided a system including: at least one processor; and at least one memory having stored thereon computer program code that, when executed by the at least one processor, instructs the at least one processor to: retrieve, from an account host, an account credit amount (e.g. of reward points or miles) associated with a user account; convert the credit amount to a monetary value based on one or more conversion rules associated with the account host; and provide an available balance of a virtual rewards account to correspond to the monetary value. In some embodiments, this balance notification may be made without transferring the value from the user account to the virtual rewards account.

The user device may host a virtual rewards card corresponding to the virtual rewards account, and the program code may further instruct the at least one processor to output for transmission, to the user device, the available balance.

The program code may further instruct the at least one processor to: update the available balance of the virtual rewards account in substantially real-time to changes in the monetary value; and output for transmission, to the user device in substantial real-time, the update to the available balance.

The changes in the monetary value may occur based on at least one of changes to an account credit amount associated with the user account or changes to conditions corresponding to the one or more conversion rules.

The program code may further instruct the at least one processor to: receive a purchase authorization request for the virtual rewards card; convert, based on the one or more conversion rules, a payment value associated with the purchase authorization request to a payment credit amount; output for transmission, to the account host, an indication of a request to deduct the payment credit amount from the account credit amount; output for transmission a payment authorization for the payment value; and output for transmission, to the user device and after transmitting the payment authorization, an available balance of the virtual rewards card based on the account credit amount.

The program code may further instruct the at least one processor to: receive a return notification for the virtual rewards account; determine a return credit amount based on a return value associated with the return notification; output for transmission, to the account host, an indication of a request to add the return credit amount from the account credit amount; and output for transmission, to the user device, the available balance of the virtual rewards card based on the return credit amount.

The return notification may correspond to a previous purchase authorization, and the program code may further instruct the at least one processor to determine the return value by: determining a payment credit amount associated with the previous purchase; and setting the return credit amount based on the payment credit amount.

The one or more conversion rules may include a location based rule, and the program code may further instruct the at least one processor to: receive, from the user device, an indication of a current location of the user device; and retrieve the account credit amount associated with the user account in response to receiving the indication of the current location.

The program code may further instruct the at least one processor to: receive, from the user device, a request for a current value of the virtual rewards account, and retrieve the account credit amount associated with the user account in response to receiving the request for the current value.

According to some embodiments, there is provided a method including: retrieving, by at least one processor and from an account host, an account credit amount associated with a user account; converting the credit amount to a monetary value based on one or more conversion rules associated with the account host; and providing, by the at least one processor, an available balance of a virtual rewards account to correspond to the monetary value.

A user device may host a virtual rewards card corresponding to the virtual rewards account, and the method may further include: outputting for transmission, to the user device, the available balance.

The method may further include: updating the available balance of the virtual rewards account in substantially real-time to changes in the monetary value; and outputting for transmission, to the user device in substantial real-time, the update to the available balance.

The changes in the monetary value occur may be based on at least one of changes to an account credit amount associated with the user account or changes to conditions corresponding to the one or more conversion rules.

The method may further include: receiving, by the at least one processor, a purchase authorization request for the virtual rewards account; converting, based on the one or more conversion rules, a payment value associated with the purchase authorization request to a payment credit amount; outputting for transmission, by the at least one processor and to the account host, an indication of a request to deduct the payment credit amount from the account credit amount; outputting for transmission, by the at least one processor, a payment authorization for the payment value; and outputting for transmission, to the user device and after transmitting the payment authorization, an available balance of the virtual rewards card based on the account credit amount.

The method may further include: receiving a return notification for the credit rewards account; determining a return credit amount based on a return value associated with the return notification; outputting for transmission, by the at least one processor and to the account host, an indication of a request to add the return credit amount from the account credit amount; and outputting for transmission, to the user device, the available balance of the virtual rewards card based on the return credit amount.

The return notification may correspond to a previous purchase authorization, and the method may further include: determining a payment credit amount associated with the previous purchase; and setting the return credit amount based on the payment credit amount.

The one or more conversion rules may include a location based rule, and the method may further include: receiving, from the user device, an indication of a current location of the user device; and retrieving the account credit amount associated with the user account in response to receiving the indication of the current location.

The method may further include: receiving, from the user device, a request for a current value of the virtual rewards account, and retrieving the account credit amount associated with the user account in response to receiving the request for the current value.

According to some embodiments, there is provided a method including: receiving, by at least one processor, a purchase authorization request to utilize a credit rewards account, the credit rewards account being associated with one or more user accounts; converting, by the processor and based on the one or more user accounts, a payment value to non-monetary credits to generate a payment credit amount; deducting the payment credit amount from a credit amount of the one or more user accounts; outputting for transmission, by the processor and in response to the deducting, a payment authorization for the payment value; and updating the virtual rewards account to reflect an available account balance of the one or more user accounts following the deducting.

The virtual rewards account may be associated with a plurality of user accounts, and the method may further include: determining respective credit amounts for each of the plurality of user accounts; converting the payment values to one or more separate payment credit amounts based on respective conversion rules of the plurality of user accounts; and deducting one or more separate payment credit amounts from one or more of the plurality of user accounts.

### BRIEF DESCRIPTION OF THE DRAWINGS

Reference will now be made to the accompanying drawings, which are incorporated into and constitute a portion of the present disclosure. The drawings may illustrate certain aspects of the disclosed technology, and, together with the description, may serve to explain the principles of the disclosed technology. In the drawings:

FIG. 1 illustrates an example environment in which one or more aspects of the present disclosure may be implemented.

FIG. 2 is a flowchart 200 an overview of using a virtual rewards card according to an example embodiment.

FIG. 3 is a timing diagram illustrating creation of a VRC according to an example embodiment

FIG. 4 is a timing diagram illustrating a purchase using a VRC according to an example embodiment.

FIG. 5 illustrates a flow diagram of processing a payment request according to an example embodiment

FIG. 6 is a block diagram of an illustrative computer system architecture, according to an example implementation

### DETAILED DESCRIPTION

Certain features of one or more example embodiment are described below with reference to one or more figures. It will be understood by one of ordinary skill that many alterations may be made to the described embodiments without departing from the scope of the present disclosure.

In some example embodiments, there may be provided a system or method that generates or updates a virtual rewards account or card (e.g., based on reward credits) in a mobile wallet in real-time. The virtual payment card may be linked to a reward credit merchant (e.g., a virtual rewards card). In some cases, the VRC may be generated or updated in real-time.

The mobile wallet may be implemented on a mobile device and, when the mobile wallet is accessed, the mobile device may access a reward account hosted by the reward credit merchant, convert a reward credit to a dollar amount, and create or update the virtual payment card in the mobile wallet for the converted dollar amount. When a purchase is attempted using the virtual rewards card, the mobile device may convert the payment amount to reward credits, and subtract the converted payment amount from the reward credits in the reward account.

In some cases, the mobile device may determine a location of the user (e.g., using a GPS of the mobile device), and present a recommended virtual rewards card based on the determined location. For example, certain reward credit merchants may limit locations that the reward credit may be used or modify a conversion ratio (e.g., reward credit to dollar ratio) for different redemption cases. For example, if an electronics store is a reward merchant, it may not allow redemption of reward credits at a rival electronics store. As another example, if an airline is a reward merchant, it may provide a greater conversion ratio for redemptions at hotels or in a destination location for a round-trip flight.

In some cases, the mobile device may detect the location of the user and update a virtual card in response to the detected location being associated with a rewards account. For example, when a user walks into a merchant's store, the mobile device may generate or update a virtual rewards card associated with that merchant.

In some cases, reward credits from multiple reward credit merchants may be accessed and combined into a single virtual rewards card. The conversions from reward credits to dollar amounts may be individualized for each reward merchant based on respective conversion ratios, and the converted dollar amounts may be combined. In response to a purchase, the mobile device may redeem the reward points for the reward merchants based on, for example, the conversion ratio.

In some implementations, there may be provided an application that can perform one or more reward redemption methods as described herein. In some cases, there may be provided a widget that enables a creation of a virtual rewards card that can be used to redeem points. The virtual rewards card may be linked to computer program code that links the virtual reward code to a reward credit of a reward credit merchant.

In some cases, once the virtual rewards card is created within a mobile wallet, it may be utilized similar to a standard credit or debit card. For example, a user may utilize the virtual rewards card to make purchases in-store, in-app, and in-browser.

One or more example embodiments may be implemented in a mobile environment, within an internet browser, or through an application (e.g., a mobile application).

In certain implementations, loyalty rewards (e.g., points, miles) may be redeemed through mobile operating system digital wallets (e.g., virtual wallets) utilizing one or more virtual rewards cards. Changes to rewards balances and the value of the rewards in dollars may be updated based on conversion rules that are synchronized and reflected within the digital wallet. The virtual rewards cards may be utilized, for example, within an eCommerce environment through websites (e.g., online use of a digital wallet) or at point of sale locations (e.g., through NFC (near field communication) or MST (magnetic secure transmission) communication). In some implementations, the virtual rewards card may be linked with existing card based and digital wallet based payment networks (e.g., Visa, Mastercard, Amex), and real-time authorization of purchased may be provided based on loyalty reward balances. In some cases, rewards balances may be adjusted based on purchases or returns performed, for example, through eCommerce or at physical points of sale.

### Example Environment

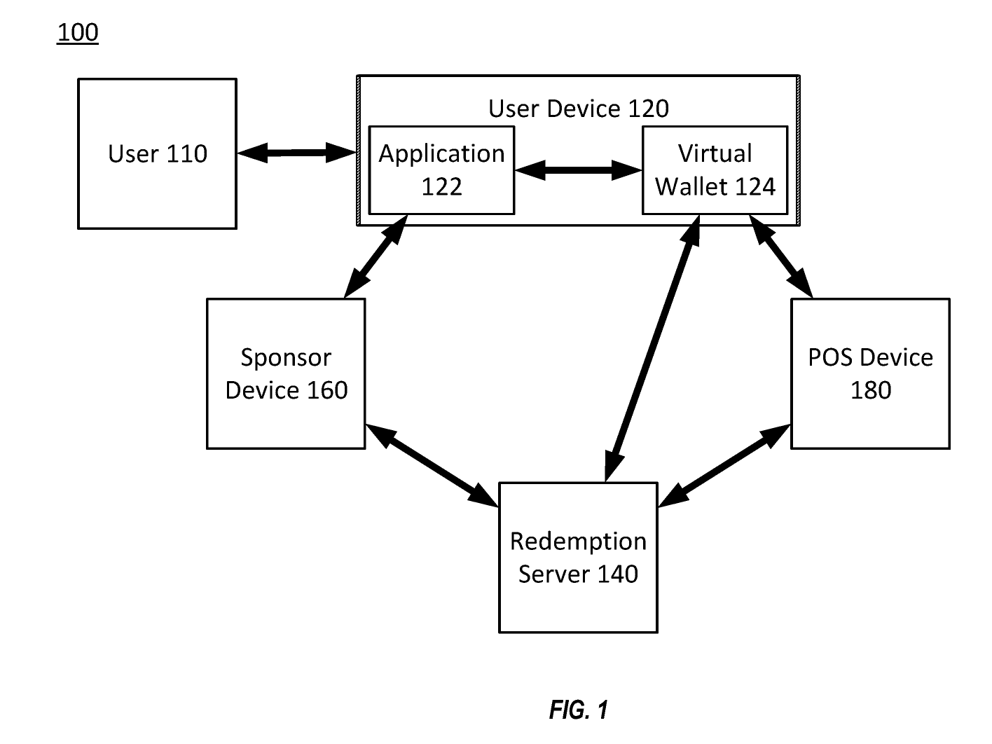

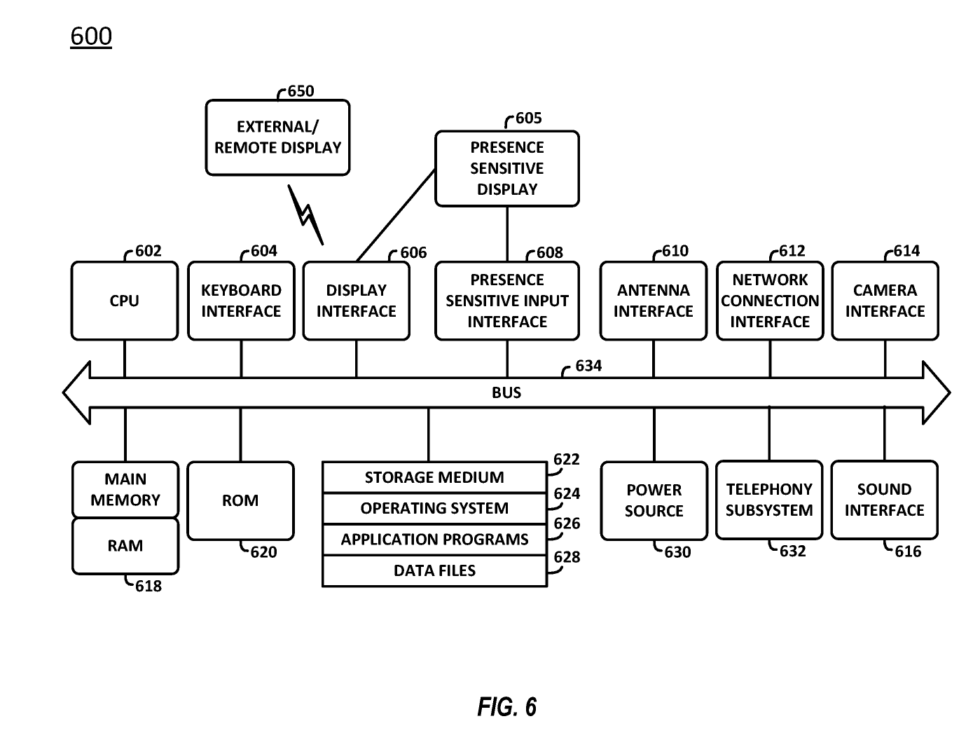

FIG. 1 illustrates an example environment 100 in which one or more aspects of the present disclosure may be implemented. The example environment includes a user device 120 (e.g., a smart phone or personal computer), a redemption server 140, a sponsor device 160 (e.g., a sponsor server or an account host), and a point-of-sale (POS) device 180. One or more of the user device 120, the redemption server 140, the sponsor device 160, and the POS device 180 may be implemented within one or more computer system architectures, for example, as described below with reference to FIG. 6.

A user 110 of the user device 120 may have an account associated with the sponsor device 160. For example, the user 110 may have a loyalty account associated with a business or credit rewards account associated with a credit card company, and the sponsor device 160 may be controlled by the corresponding business or credit card company. The user device 120 may request a virtual rewards card associated with the loyalty account from the sponsor device 160. For example, the user device 120 may execute an application 122 associated with the loyalty account and request the virtual rewards card from the sponsor device 160 through the application 122. In some cases, the user device 120 may install the application 122 in order to request or generate the VRC. Once created, the virtual rewards card may be placed within a virtual wallet 124 (e.g., Apple Pay, MasterPass, Android Pay, Samsung Pay, Chase Pay, Wells Fargo Wallet, etc.) implemented on the user device 120. A balance of the VRC may be displayed within the virtual wallet 124. In some cases, the balance may be updated in substantially real-time based on notification from the redemption server 160.

The sponsor device 160 may maintain the loyalty account of the user 110. For example, the sponsor device 160 may track a user's available points and point redemption. The sponsor device 160 may receive the request for a virtual rewards card from the user device 120, and forward the request to the redemption server 140. The sponsor device 160 may relay the virtual rewards card to the user device 120 and provide status updates of the loyalty account (e.g., current points) to the redemption server 140. One of ordinary skill will recognize that, in some implementations, sponsor device 160 may be representative of one or more devices or systems. For example, in some embodiments, sponsor device 160 may include a rewards database (e.g., a points database or a miles database) or a rewards data store (e.g., a points data store or a miles data store). Redemption server 140 may communicate with the rewards database or data store to determine a current balance of a loyalty account.

The redemption server 140 creates a virtual rewards account/virtual rewards card and sends the same to the sponsor device 160. In some cases, the redemption server 140 may maintain current dollar balances of the virtual rewards card in the virtual wallet 124, for example, by continuously or periodically sending current dollar balances to the virtual wallet 124. For example, the redemption server 140 may request current point totals from the sponsor device 160, convert the points to a dollar value (e.g., based on a current location of the user device 120), and push a current dollar value of the VRC to the virtual wallet 124 on the user device 120. In some cases, the redemption server 140 may communicate directly with the user device 120. In other instances, the redemption server 140 may communicate with the user device 120 through the sponsor device 160, a third-party messaging service, or some other device. In some cases, the redemption server 140 may provide messages to the user device 120 based on rewards activity or availability (e.g., special values based on a current location of the user device 120). In some cases, a card processor creates the virtual rewards account based on information from the redemption server 140, and the redemption server 140 manages the account. The card processor may be a third-party card processor or may be implemented as a virtual card processor.

In some cases, the redemption server 140 may connect the VRC to the loyalty account in near real-time (e.g., substantial real-time). In some implementations, the value of the VRC may be updated in near real-time (e.g., substantial real-time), for example, based on changes to merchant identity or user device 120 location.

The POS device 180 initiates processing of purchases of the virtual rewards card. For example, when a user 110 of the user device 120 attempts to use the virtual rewards card at a merchant, the POS device 180 receives information from the virtual wallet 124, and the POS device 180 authorizes the purchase with the redemption server 140, for example, through a payment network. The redemption server 140 confirms an available value for the virtual rewards card (e.g., by confirming points with the sponsor device 160), and authorizes the purchase.

In some cases, the POS device 180 may be a physical device at a merchant location. In some circumstances, the POS device 180 may be contacted through an application executing on the user device 120 or through a web portal (e.g., accessed on the user device 120). In some circumstances, the POS device 180 may include a third-party payment processor device utilized by a merchant to process purchases. In some cases, various digital payment methods (e.g., Apple Pay, Visa Checkout, MasterPass, etc.) may convey information associated with the virtual rewards card to the POS device 180.

One of ordinary skill will recognize that, in some cases, an example environment may include plurality of sponsor devices 160. For example, multiple virtual rewards cards may be created correspond to different loyalty accounts. In some instances, a single virtual rewards card may correspond to a plurality of different loyalty accounts associated with different sponsor devices 160. In such a case, the redemption server 140 may convert and combine points from different sponsor devices 160 using different rules.

In some cases, a plurality of user devices 120 may be associated with a single user 110. In such cases, a virtual rewards card may be inserted into a respective virtual wallet 124 implemented on each of the plurality of user devices 120. In some circumstances, a single virtual rewards card may be held in a plurality of virtual wallets 124 on a single user device 120. For example, a VRC may be stored within a phone wallet (e.g., Apple Pay, Android Pay, Samsung Pay), a Bank Wallet (e.g., Citi Pay, Wells Fargo Wallet, Capital One Wallet), and/or an Online Card Wallets (e.g., Visa Checkout, MasterPass).

Moreover, one of ordinary skill will understand that, while the user device 120, redemption server 140, sponsor device 160, and POS device 180 are illustrated as distinct devices, this is merely an example. In some implementations, one or more of the user device 120, redemption server 140, sponsor device 160, and POS device 180 or features thereof may be combined within one or more devices. Further, it will be understood that certain embodiments may include multiple distinct elements forming one or more of the user device 120, redemption server 140, sponsor device 160, and POS device 180.

### Virtual Redemption Cards Creation and Use

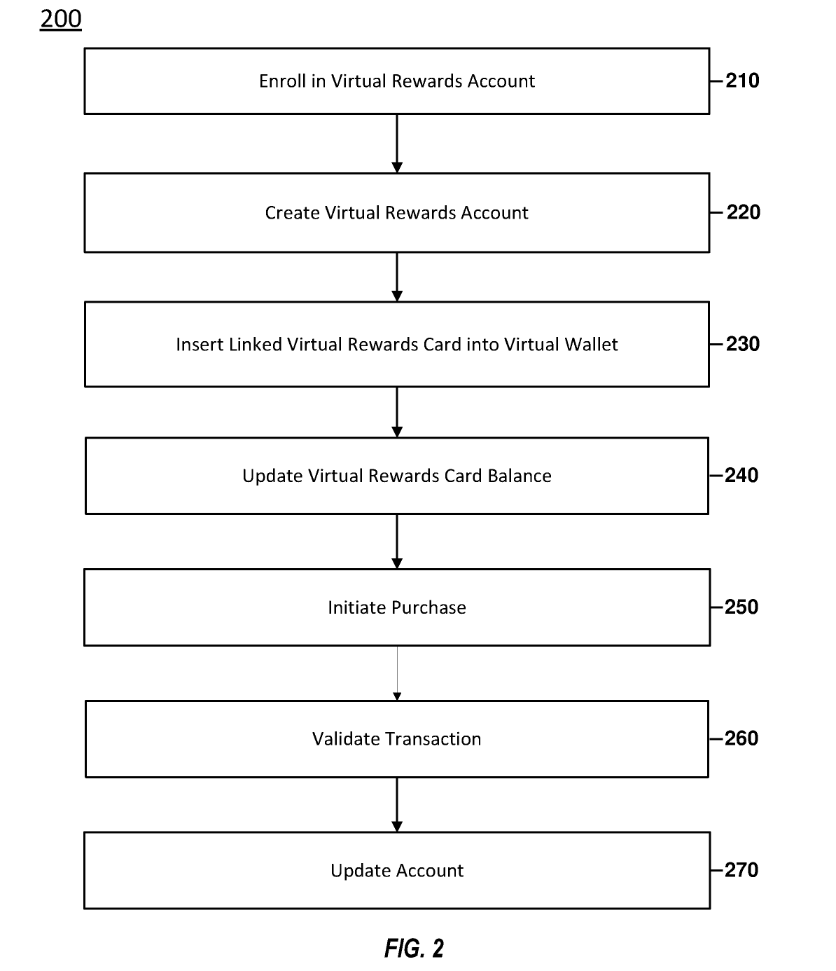

FIG. 2 is a flowchart 200 illustrating an overview of using a virtual rewards card according to an example embodiment. At 210 the user device 120 enrolls in a virtual rewards account. One of ordinary skill will recognize that, in some implementations, enrollment may only be necessary once for each user device 120 and/or once for each loyalty account. For example, a user 110 of the user device 120 may input an indication for linking a loyalty account with the virtual wallet 124. In some cases, the user device 120 may provide information necessary for enrollment (e.g., registration information) to the sponsor device 160. For example, registration information may include information associated with the user's 110 loyalty account (e.g., account name, telephone number, e-mail address), virtual wallet selection (e.g., if one or more virtual wallets 124 available), terms and conditions acceptance, and a user token (e.g., user validation token). In some cases, the user device 120 generates the user token. In some circumstances, the user 110 must input certain registration information into the user device 120. In some implementations, registration information may be known or discovered by the sponsor server 160 by referencing the loyalty account.

In some cases, the sponsor device 160 sends an e-mail to the user 110 at an e-mail address associated with the loyalty account. The user 110 may access the e-mail on the user device 120. The e-mail may link to the loyalty account (e.g., the application 122 associated with the loyalty account or a website associated with the loyalty account). The user 110 may log into the loyalty account (e.g., through the application 122 or website), and indicate that they would like a virtual rewards card to be added to the virtual wallet 124. The user device 120 (e.g., application 122) may contact the sponsor device 160, which passes the registration information to the redemption server 140.

According to certain implementation, the functionality for the user 110 to add the VRC to their wallet may be provided in various ways. For example, in some embodiments, a mobile application (e.g., application 122) of a Loyalty Program may include VRC addition functionality. For example, the mobile application may incorporate an SDK provided in association with redemption server 140. In some implementations, a mobile application (e.g., application 122) may be associated with redemption server 140 and may provide VRC-addition functionality to user device 120. In some cases, a website corresponding to the Loyalty Program may include the VRC-addition functionality, for example, by implementing routines provided in association with the redemption server 140.

At 220, the redemption server 140 creates a virtual rewards account (VRA). The VRA may include, for example, an account number, an expiration, a verification value (e.g., a Card Verification Value), a billing address, a shipping address, and user information. In some cases, the shipping and billing addresses may be associated with the user 110. In other circumstances, the billing and shipping addresses may be associated with an entity controlling the redemption server 140. In some implementations, the redemption server 140 may receive and create the VRA based on one or more of user 110 information, loyalty account information, and sponsor device 160 information. Once the VRA is created, the redemption server 140 may transmit an authorization token to authorize a virtual rewards card (VRC) linked to the VRA. One of ordinary skill will recognize that, in some cases, a single VRA is created for each user 110 (e.g., a single VRA per user account). Accordingly, once a VRC is added to a first user device 120 of the user 110, the same VRA account would be used to add a VRC to a second user device 120 of the user 110.

At 230, the user device 120 inserts a virtual rewards card (VRC) into the virtual wallet 124. Once the VRA is created, the user device 120 may receive the authorization token and VRA information from the redemption server 140 (e.g., through the sponsor device 160). The VRA data may be provided to the virtual wallet 124 (e.g., from application 122), which may then contact a card issuer (e.g., redemption server 140) and a payment network to verify the VRC. Once verified, the VRC is added to the virtual wallet 124. In some implementations, the user device 120 may access a separate application (e.g., associated with the redemption server 140) configured to establish a virtual rewards card within the virtual wallet 124.

At 240, an account balance of the VRC is updated. For example, the redemption server 140 may retrieve a points balance from the sponsor device 160. The redemption server 140 may convert the points to a value amount based on, for example, rules established by the sponsor device 160, a location of the user device 120, and the like. In some cases, the redemption server 140 may routinely request points balances from the sponsor device 160. In some implementations, the sponsor device 160 may notify the redemption server 140 if a points balance has changed. In certain case, the user device 120 may request an update to the account balance from the redemption server 140 (e.g., in response to a user indication or the virtual wallet 124 being activated). The redemption server 140 may transmit a notification to the virtual wallet 124 that the value has been updated. In some implementations, the notification may be a push notification transmitted through a notification service. The push notification may instruct the virtual wallet 124 to ask the redemption server 140 for updated details of the virtual rewards card. In other implementations, the redemption server 140 may output a message directly to the virtual wallet 124 that informs the virtual wallet 124 of the details of the virtual rewards card.

At 250, the user device 120 initiates a purchase using the VRC. For example, the user 110 may attempt to purchase merchandise at a merchant location using the VRC. The user device 120 may provide information on the VRC to the POS device 180.

At 260, the purchase is authorized. As a non-limiting example, the POS device 180 may receive the VRC information from the user device 120, and request authorization from the redemption server 140. The redemption server 140 determines whether sufficient funds are available in the VRA (e.g., whether the loyalty account has sufficient points), converts the transaction amount into points, and deducts the points from the loyalty account. By utilizing the redemption server 140 within the purchase authorization, in some cases, purchases may be approved in real-time based on changing conditions. For example, in some cases redemption authorizations may be affected by the sponsor device 160 or user settings. As non-limiting examples, transactions may be limited by capped transaction values, transactions may be limited to particular merchants, retail offers, coupons, discounts may be applied in real-time to enhance point values (e.g., raise a maximum transaction value), and point to value ratios may be adjusted based on locations of the user device 120 (e.g., based on a current store visited by the user 110). In some cases, a merchant ID may be provided with a transaction authorization request, and a conversion rate may be specific to a particular merchant or type of merchant.

At 270, the redemption server 140 requests an updated points balance from the sponsor device 160. The redemption server 140 converted the updated points balance into a value, and provides the updated value to the virtual wallet 124. For example, the redemption server 140 may request that a push notification service updates the VRC in the virtual wallet 124.

One of ordinary skill will recognize that certain portions of FIG. 2 described above may not be utilized in every implementation of aspects of the present disclosure. For example, in certain cases, the enrollment at 210, the VRA creation at 220, the VRC insertion at 230, and account balance update at 240 may be performed separately or not at all.

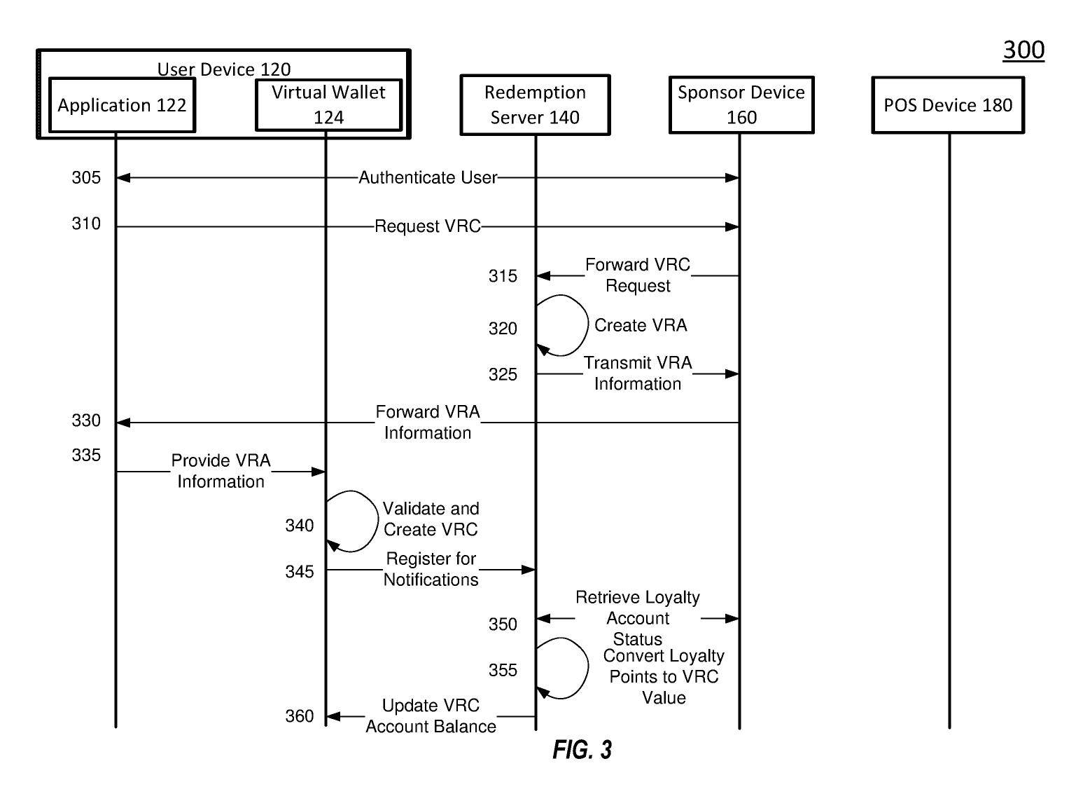

FIG. 3 is a timing diagram 300 illustrating creation of a VRC according to an example embodiment. At 305, application 122 authenticates the user 110 with the sponsor device 160. For example, the user 110 may input loyalty account credentials (e.g., account name and password) into the application 122, and the application 122 may control the user device 120 to transmit the credentials to the sponsor device 160. At 310, the application 122 requests the creation of a VRC linked to the loyalty account. The request is submitted to the sponsor device 160. The application 122 may pass enrollment information of the user 110 (e.g., name, address, etc.) with the request based on the loyalty account.

At 315, the sponsor device 160 forwards the request to the redemption server 140. In some cases, the sponsor device 160 may transmit a user token along with the request. The user token may be used to verify requests for access to the loyalty account. At 320 the redemption server 140 creates a VRA. For example, the redemption server 140 may request that a card processor generate a VRA, which returns the card information to the redemptions server 140. At 325, the redemption server sends the card information to the sponsor device 140, which forwards the card information to the application 122 at 330. Then, at 335, the application 122 provides the card information to the virtual wallet 124. In some cases, the card information includes an authentication token which may be used to verify the user device 120 as an authorized device for the VRA.

At 340, the virtual wallet 124 validates and creates the VRC. For example, the virtual wallet 124 may validate the VRC with a payment network. In some cases, the authentication token is used to verify that the user device 120 may add the VRC to the virtual wallet 124. Once validated, at 345, the virtual wallet 124 registers for notifications with the redemption server 140. However, this is merely an example, and registering for notifications may not always be required. The VRC may be created in response to the user 110 initiating a request to add the VRC to the virtual wallet 124. In some cases, a card processor provides card provision advice (e.g., a token corresponding to the VRA) to the virtual wallet 124. This token may be used to confirm registration of a VRC from the virtual wallet 124 and, in some cases, for processing purchase requests.

At 350 the redemption server 140 may retrieve reward points from the sponsor device 160. For example, the redemption server 140 may periodically submit an inquiry to the sponsor device 160 (e.g., together with the user token) or the sponsor device 160 may notify the redemption server 140 when the account is updated. At 355, the redemption server converts the points to a value. As non-limiting examples, the conversion may be determined based on one or more of rules provided by the sponsor device 160, time of day, user device 120 location, merchant identity (e.g., certain merchants may provide a bonus conversion rate), available coupons, user 110 reward tier (e.g., gold, silver, platinum), or particular marketing campaigns.

At 360, after the VRC is added to the virtual wallet 124, the redemption server 140 updates the account balance of the VRC at the virtual wallet 124. As a non-limiting example, the redemption server 140 may provide a push notification (e.g., through a push-notification service) to the virtual wallet 124 that the VRC balance has been updated. The virtual wallet 124 may then request a current card status from the redemption server 140. In some cases, the virtual wallet 124 may initiate the update, for example, by requesting a current status of the VRC in response to the user 110 signing into or opening the virtual wallet 124. In some implementations, the redemption server 140 may output a message directed to the virtual wallet 124 that updates the VRC (e.g., without the use of a push notification service).

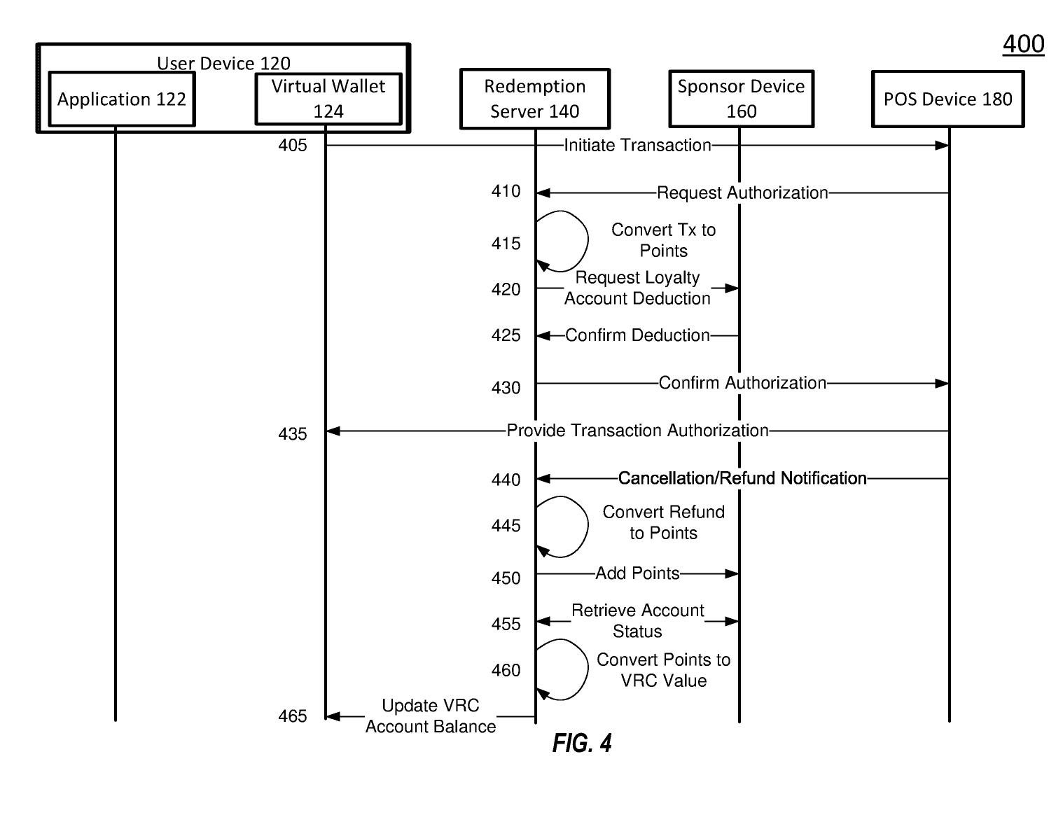

FIG. 4 is a timing diagram 400 illustrating a purchase using a VRC according to an example embodiment. At 405, the wallet 124 initiates a transaction with a POS device 180. For example, the transaction may be initiated using NFC, through an in-app purchase, or using eCommerce. At 410, the POS device 180 requests authorization of the purchase from the redemption server 140 via the acquirer/network/issuer. In some cases, the authorization may be requested to payment network and/or a payment processor, which then requests authorization from the redemption server 140. In some cases, the wallet 124 provides a payment token to the POS device 180, and the POS device likewise provides the payment token to the redemption server 140. The transaction request received by the redemption server 140 may include one or more of the payment token, a merchant ID corresponding to a merchant associated with the POS device 180, the purchase amount, a tokenized identifier for the VRC, and a time/date of the transaction.

At 415, the redemption server 140 converts an amount of the transaction into transaction points, for example, using similar rules as those discussed above with reference to 355 of FIG. 3. At 420, the redemption server 140 requests that the sponsor device 160 reduce the points of loyalty account by the transaction points. In some cases, the redemption server must transmit a user token verifying account access and the payment token verifying the proposed transaction for the sponsor device 160 to honor the point deduction request. At 425, the sponsor device 160 confirms that the transaction points have been successfully deducted. That is, if sufficient points to honor the deduction are available in the loyalty account, the points may be deducted and the transaction may be approved.

At 430, the redemption server 140 confirms that the purchase has been authorized using the VRC. At 435, the POS device 180 notifies the wallet 124 that the transaction is authorized. However, this is merely an example in a case where sufficient points are available in the loyalty account. In some cases, insufficient points may be available, and the transaction may be declined. The redemption server 140 may contact the user device 120 (e.g., through a text message or e-mail) to indicate a basis for declining the transaction (e.g., insufficient points, unauthorized merchant, unidentified merchant, incorrect merchant type, violation of a fraud rule (e.g., purchase amount or frequency), unresponsive sponsor device 160, or violation of some user-defined rule). In some cases, if insufficient points are available, the redemption server 140 may deduct a value of available points from the transaction price and request the balance of the transaction price to be paid using a separate payment mechanism (e.g., a registered credit card account). In such cases, the VRC may be used to partially pay for a transaction.

In some embodiments, at 440, the redemption server 140 may be notified that a transaction has been cancelled or partially refunded (e.g., by the card processor or the POS device 180). In such cases, at 445, the redemption server 140 may convert the value of the cancellation or refund into refund points and, at 450, request that the sponsor device 160 add the refund points to the loyalty account. In some instances, each authorized transaction may be associated with a transaction id. To facilitate a refund, the return or cancellation must be linked to the corresponding transaction id. In such a case, the points refunded would correspond to the amount of points debited to authorize the purchase. Thus, for example, if certain factors led to an enhanced conversion rate for authorizing the transaction, the refund would be subject to the same enhanced conversion rate.

At 455, after the transaction is finalized (e.g., payment, refund, or partial payment), the redemption server 140 may retrieve current reward points from the sponsor device 160. At 460, the redemption server 140 converts the current points to a value. At 465, the redemption server 140 updates the account balance of the VRC at the virtual wallet 124. As a non-limiting example, the redemption server 140 may provide a push notification (e.g., through a push-notification service) to the virtual wallet 124 that the VRC balance has been updated. One of ordinary skill will recognize that this is merely an example. In some cases, the redemption server 140 may update the account balance regularly (e.g., through polling), when prompted by the sponsor device 160, or when requested by the user device 120. In some embodiments, the updating may occur even if a transaction (e.g., purchase or return) does not occur. In some implementations, the updating may be performed asynchronously after a transaction is authorized.

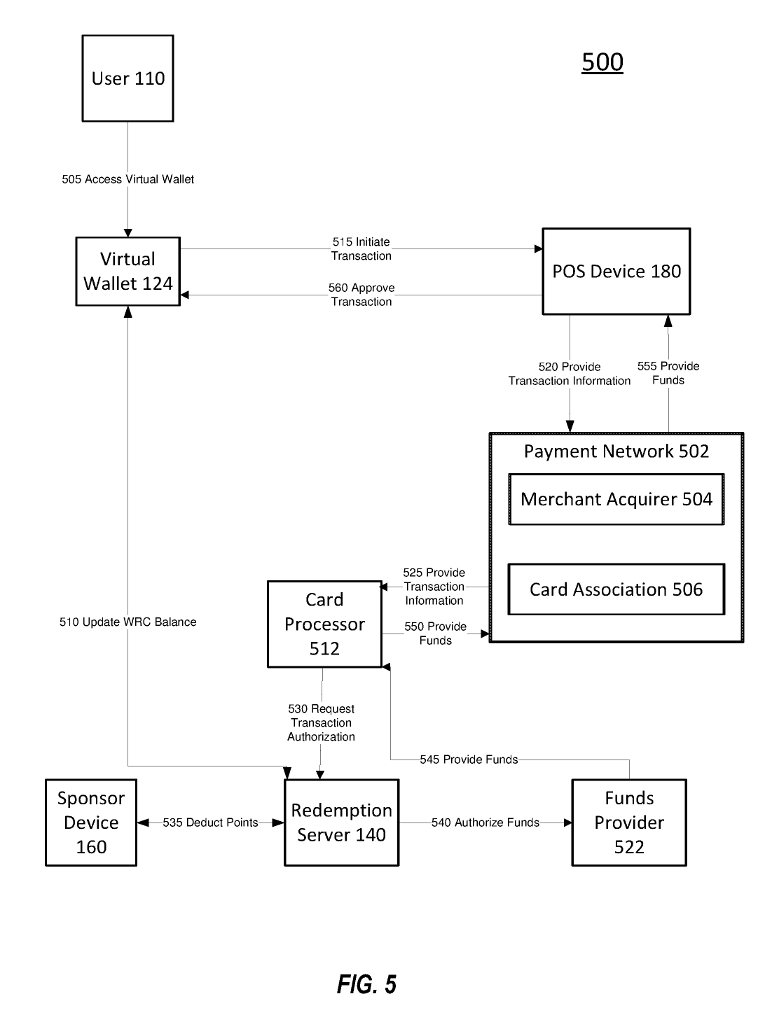

FIG. 5 illustrates a flow diagram 500 of processing a payment request according to an example embodiment. At 505 a user 110 accesses a virtual wallet 124 on a user device 120. At 510, the virtual wallet 124 may update the balance of the virtual rewards card (e.g., by requesting a balance update from the redemption server 160). At 515, the virtual rewards card is used at a POS device 180 to initiate a transaction (e.g., to pay for a purchase). At 520 POS device 180 provides the transaction information to a payment network 502. The payment network 502 may include, as non-limiting examples, a merchant acquirer 504 and a card association 506 (e.g., Visa or MasterCard networks). In some implementations, a merchant (e.g., POS device 180) received a payment token from a user device 120; the merchant provides the payment token to an acquirer 504, which forwards the token to a payment network. The token is then sent to a token service provider, which provides the token to an issuer to receive payment information.

At 525, the payment network 502 provides the transaction information to a card processor 512. Although the card processor 512 is depicted as separate from the payment network 502, this is merely an example, and, in some cases, the card processor 512 may be considered part of the payment network 502.

At 530, the card processor 512 requests the redemption server 140 to authorize the transaction. At 535, the redemption server 140 deducts the requisite points from the loyalty account at the sponsor device 160. At 540, the redemption server 140 instructs a funds provider 522 (e.g., an issuing bank) to provide funds to the card processor 512 to fund the transaction (e.g., authorizing the transaction). At 545, the funds provider 522 provides funds to the card processor 512, which transmits the funds to POS device 180 through the payment network 502 at 550 and 555. At 560, the POS device 180 notifies the virtual wallet 124 that the transaction is completed.

In some implementations, after the transaction completes, the balance of the VRC may be again updated. For example, the virtual wallet 124 may request a balance update from the redemption server 160. As another example, the redemption server 160 may notify the virtual wallet 124 that the balance has been updated. In some implementations, each virtual wallet 124 with a VRC corresponding to the same VRA is updated. For example, if the user 110 has a plurality of user devices 120 and/or different virtual wallets 124, the redemption server 160 may notify each of the different virtual wallets 124 that the balance of the VRC has been updated.

### Additional Aspects of Certain Embodiments

In some embodiments, the virtual wallet 124 functionality may be combined with geolocation services included with the user device 120. Geolocation services provide an estimate of a location of the user device 120. For example, in some cases user device 120 may include a GPS receiver which can determine a location of the user device 120. However, this is merely an example and many alternatives would be known to one of ordinary skill.

In some implementations, messages may be provided to the user device 120 (e.g., pop-up messages) in response to the user device 120 entering or being within distance of one or more participating retail stores. For example, the messages may indicate one or more of certain reward program points may be utilized within a participating store, bonuses associated with store statuses (e.g., extra points when using a VRC if you have membership status at a store), and additional points back or a discount when using a VRC during a particular time period.

In some cases, suggestions of joining one or more programs (e.g., loyalty programs) may be provided to a user 110 through the user device 120. For example, geographic locations may be associated with one or more loyalty programs, and a notification to join a loyalty program may be provided to the user device 120 in response to the user device 120 being located at the associated location. In certain cases, a notification that points may be redeemed at a particular store in response to determining the user device 120 enters the store's location. As another example, spending habits may be analyzed and particularly valuable programs (e.g., loyalty programs) may be identified and suggested based on the spending habits analysis.

In some implementations, discounts and offers based on merchant codes and other criteria may be available. In some cases, the redemption server 140 may determine locations corresponding to the merchant codes and provide the user 110 with discounts or offers when in a location corresponding to the merchant code. In some cases, independent offers from particular merchants may be identified and reported to the user device 120.

In some implementations, using a VRC may provide earned points to the loyalty account (e.g., a redemption bonus). In certain cases, one or more of biometric authentication, transaction and user tokenization, and device pairing may be utilized to detect and prevent fraud.

In some embodiments, rewards balances from multiple loyalty accounts (e.g., multiple sponsor devices 160) may be combined and utilized within by a single VRC. Points from each loyalty account may be converted to values independently. For example, each sponsor device 160 may establish a conversion rate, usable locations, and any special modifications (e.g., modifications to the conversion rate). The redemption server 140 may retrieve point balances from each of the multiple sponsor devices 160, calculate the current value, and aggregate the values to provide greater purchasing power. In some cases, points are aggregated formulaically in substantially real-time. When a transaction is performed, points may be redeemed in various orders. As a non-limiting example, points may be redeemed from programs having the most points, in reverse point-expiration data, based on relative point values (e.g., if certain loyalty accounts provide additional point redemption benefits for a particular purchase), or user settings. However, these are merely examples and various alternatives will be understood and anticipated by one of ordinary skill based on the present disclosure. An example aggregation of three programs is illustrated below in Table 1.

TABLE 1

| | Available | Current Redemption | |
|---|---|---|---|
| Program | Points | Ratio | Value |
| Program A “Your Bank” | 10,000 | 5.0095/point | 95 |
| Program B “Travel | 20,000 | 5.005/point | 100 |
| Miles” | | | |
| Program C “Retail | 500 | 5.75/point | 375 |
| Rewards” | | | |

| | |
|---|---|
| Total Value | 570.00 |

In the event of a refund, credits may be provided back to the program point balances in the same proportion based on original amounts debited.

In some cases, there may be provided tools (e.g., through an application on the user device 120 or through the redemption server 140) that may enhance the overall optimization of loyalty points earning and redemption. For example, as discussed above, when multiple points programs are combined in a single VRC, if certain loyalty accounts provide additional point redemption benefits for a particular purchase, such loyalty account points will be utilized first. As another example, certain tools may recommend strategic, complementary loyalty programs for point combining (e.g., particular airlines and hotels).

### Example Computer Architecture

FIG. 6 is a block diagram of an illustrative computer system architecture 600, according to an example implementation. The computer system architecture 600 may be used to implement one or more example embodiments within the scope of the present disclosure. In some cases, one or more elements of the computer system architecture 600 may be combined to embody one or more of a user device 120, a redemption server 140, a sponsor device 160, a POS device 180, one or more portions of a payment network 502, a card processor 512, and a funds provider 522. It will be understood that the computing device architecture 600 is provided for example purposes only and does not limit the scope of the various implementations of the present disclosed systems, methods, and computer-readable mediums.

The computing device architecture 600 of FIG. 6 includes a central processing unit (CPU) 602, where computer instructions are processed, and a display interface 604 that acts as a communication interface and provides functions for rendering video, graphics, images, and texts on the display. In certain example implementations of the disclosed technology, the display interface 604 may be directly connected to a local display, such as a touch-screen display associated with a mobile computing device. In another example implementation, the display interface 604 may be configured for providing data, images, and other information for an external/remote display 650 that is not necessarily physically connected to the mobile computing device. For example, a desktop monitor may be used for mirroring graphics and other information that is presented on a mobile computing device. In certain example implementations, the display interface 604 may wirelessly communicate, for example, via a Wi-Fi channel or other available network connection interface 612 to the external/remote display 650.

In an example implementation, the network connection interface 612 may be configured as a communication interface and may provide functions for rendering video, graphics, images, text, other information, or any combination thereof on the display. In one example, a communication interface may include a serial port, a parallel port, a general-purpose input and output (GPIO) port, a game port, a universal serial bus (USB), a micro-USB port, a high definition multimedia (HDMI) port, a video port, an audio port, a Bluetooth port, a near-field communication (NFC) port, another like communication interface, or any combination thereof. In one example, the display interface 604 may be operatively coupled to a local display, such as a touch-screen display associated with a mobile device. In another example, the display interface 604 may be configured to provide video, graphics, images, text, other information, or any combination thereof for an external/remote display 650 that is not necessarily connected to the mobile computing device. In one example, a desktop monitor may be used for mirroring or extending graphical information that may be presented on a mobile device. In another example, the display interface 604 may wirelessly communicate, for example, via the network connection interface 612 such as a Wi-Fi transceiver to the external/remote display 650.

The computing device architecture 600 may include a keyboard interface 606 that provides a communication interface to a keyboard. In one example implementation, the computing device architecture 600 may include a presence-sensitive display interface 608 for connecting to a presence-sensitive display 607. According to certain example implementations of the disclosed technology, the presence-sensitive display interface 608 may provide a communication interface to various devices such as a pointing device, a touch screen, a depth camera, etc. which may or may not be associated with a display.

The computing device architecture 600 may be configured to use an input device via one or more of input/output interfaces (for example, the keyboard interface 606, the display interface 604, the presence sensitive display interface 608, network connection interface 612, camera interface 614, sound interface 616, etc.) to allow a user to capture information into the computing device architecture 600. The input device may include a mouse, a trackball, a directional pad, a track pad, a touch-verified track pad, a presence-sensitive track pad, a presence-sensitive display, a scroll wheel, a digital camera, a digital video camera, a web camera, a microphone, a sensor, a smartcard, and the like. Additionally, the input device may be integrated with the computing device architecture 600 or may be a separate device. For example, the input device may be an accelerometer, a magnetometer, a digital camera, a microphone, and an optical sensor.

Example implementations of the computing device architecture 600 may include an antenna interface 610 that provides a communication interface to an antenna; a network connection interface 612 that provides a communication interface to a network. As mentioned above, the display interface 604 may be in communication with the network connection interface 612, for example, to provide information for display on a remote display that is not directly connected or attached to the system. In certain implementations, a camera interface 614 is provided, which acts as a communication interface and provides functions for capturing digital images from a camera. In certain implementations, a sound interface 616 is provided as a communication interface for converting sound into electrical signals using a microphone and for converting electrical signals into sound using a speaker. According to example implementations, a random-access memory (RAM) 618 is provided, where computer instructions and data may be stored in a volatile memory device for processing by the CPU 602.

According to an example implementation, the computing device architecture 600 includes a read-only memory (ROM) 620 where invariant low-level system code or data for basic system functions such as basic input and output (I/O), startup, or reception of keystrokes from a keyboard are stored in a non-volatile memory device. According to an example implementation, the computing device architecture 600 includes a storage medium 622 or other suitable type of memory (e.g., such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives), where the files include an operating system 624, application programs 626 (including, for example, a web browser application, a widget or gadget engine, and or other applications, as necessary) and data files 628 are stored. According to an example implementation, the computing device architecture 600 includes a power source 630 that provides an appropriate alternating current (AC) or direct current (DC) to power components.

According to an example implementation, the computing device architecture 600 includes a telephony subsystem 632 that allows the device 600 to transmit and receive sound over a telephone network. The constituent devices and the CPU 602 communicate with each other over a bus 634.

According to an example implementation, the CPU 602 has appropriate structure to be a computer processor. In one arrangement, the CPU 602 may include more than one processing unit. The RAM 618 interfaces with the computer bus 634 to provide quick RAM storage to the CPU 602 during the execution of software programs such as the operating system application programs, and device drivers. More specifically, the CPU 602 loads computer-executable process steps from the storage medium 622 or other media into a field of the RAM 618 in order to execute software programs. Data may be stored in the RAM 618, where the data may be accessed by the computer CPU 602 during execution.

The storage medium 622 itself may include a number of physical drive units, such as a redundant array of independent disks (RAID), a floppy disk drive, a flash memory, a USB flash drive, an external hard disk drive, thumb drive, pen drive, key drive, a High-Density Digital Versatile Disc (HD-DVD) optical disc drive, an internal hard disk drive, a Blu-Ray optical disc drive, or a Holographic Digital Data Storage (HDDS) optical disc drive, an external mini-dual in-line memory module (DIMM) synchronous dynamic random access memory (SDRAM), or an external micro-DIMM SDRAM. Such computer readable storage media allow a computing device to access computer-executable process steps, application programs and the like, stored on removable and non-removable memory media, to off-load data from the device or to upload data onto the device. A computer program product, such as one utilizing a communication system may be tangibly embodied in storage medium 622, which may include a machine-readable storage medium.

According to one example implementation, the term computing device, as used herein, may be a CPU, or conceptualized as a CPU (for example, the CPU 602 of FIG. 6). In this example implementation, the computing device (CPU) may be coupled, connected, and/or in communication with one or more peripheral devices, such as display. In another example implementation, the term computing device, as used herein, may refer to a mobile computing device such as a smart phone, tablet computer, or smart watch. In this example implementation, the computing device may output content to its local display and/or speaker(s). In another example implementation, the computing device may output content to an external display device (e.g., over Wi-Fi) such as a TV or an external computing system.

In example implementations of the disclosed technology, a computing device may include any number of hardware and/or software applications that are executed to facilitate any of the operations. In example implementations, one or more I/O interfaces may facilitate communication between the computing device and one or more input/output devices. For example, a universal serial bus port, a serial port, a disk drive, a CD-ROM drive, and/or one or more user interface devices, such as a display, keyboard, keypad, mouse, control panel, touch screen display, microphone, etc., may facilitate user interaction with the computing device. The one or more I/O interfaces may be used to receive or collect data and/or user instructions from a wide variety of input devices. Received data may be processed by one or more computer processors as desired in various implementations of the disclosed technology and/or stored in one or more memory devices.

One or more network interfaces may facilitate connection of the computing device inputs and outputs to one or more suitable networks and/or connections; for example, the connections that facilitate communication with any number of sensors associated with the system. The one or more network interfaces may further facilitate connection to one or more suitable networks; for example, a local area network, a wide area network, the Internet, a cellular network, a radio frequency network, a Bluetooth enabled network, a Wi-Fi enabled network, a satellite-based network any wired network, any wireless network, etc., for communication with external devices and/or systems.

According to some implementations, computer program code may be configured to control a computer device, e.g., the computer system architecture 600, to implement one or more components of one or more embodiments. According to some implementations, computer program code may be configured to control a computer device implement one or more methods within the scope of the present disclosure.

Although some example embodiments described herein have been described in language specific to computer structural features, methodological acts, and by computer readable media (e.g., non-transitory computer readable media), it is to be understood that the disclosure is not necessarily limited to the specific structures, acts or media described. Therefore, the specific structural features, acts and mediums are disclosed as example embodiments implementing the disclosure. The present disclosure is intended to cover various modifications and equivalent arrangements including those within the scope of the appended claims and their equivalents. Although specific terms are employed herein, they are used in a generic and descriptive sense only and not for purposes of limitation.

Although example embodiments of the present disclosure described herein are explained in detail, it is to be understood that other embodiments are contemplated. Accordingly, it is not intended that the present disclosure be limited in its scope to the details of construction and arrangement of components set forth in the following description or illustrated in the drawings. The present disclosure is capable of other embodiments and of being practiced or carried out in various ways.

It must also be noted that, as used in the specification and the appended claims, the singular forms “a,” “an” and “the” include plural referents unless the context clearly dictates otherwise. Moreover, titles or subtitles may be used in this specification for the convenience of a reader, which shall have no influence on the scope of the present disclosure.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

In describing example embodiments, certain terminology has been resorted to for the sake of clarity. It is intended that each term contemplates its broadest meaning as understood by those skilled in the art and includes all technical equivalents that operate in a similar manner to accomplish a similar purpose.

It is to be understood that the mention of one or more steps or blocks of a method does not preclude the presence of additional method steps or intervening method steps between those steps expressly identified. Steps of a method may be performed in a different order than those described herein. Similarly, it is also to be understood that the mention of one or more components in a device or system does not preclude the presence of additional components or intervening components between those components expressly identified.

1. A system comprising:
at least one processor; and
at least one memory having stored thereon computer program code that, when executed by the at least one processor, instructs the at least one processor to:
retrieve, from an account host, an account credit amount associated with a user account;
convert the credit amount to a monetary value based on one or more conversion rules associated with the account host; and
provide an available balance of a virtual rewards account to correspond to the monetary value.

2. The system of claim 1, wherein a user device hosts a virtual rewards card corresponding to the virtual rewards account, and the program code further instructs the at least one processor to:
output for transmission, to the user device, the available balance.

3. The system of claim 2, wherein the program code further instructs the at least one processor to:
update the available balance of the virtual rewards account in substantially real-time to changes in the monetary value; and
output for transmission, to the user device in substantial real-time, the update to the available balance.

4. The system of claim 3, wherein the changes in the monetary value occur based on at least one of changes to an account credit amount associated with the user account or changes to conditions corresponding to the one or more conversion rules.

5. The system of claim 2, wherein the program code further instructs the at least one processor to:
receive a purchase authorization request for the virtual rewards card;
convert, based on the one or more conversion rules, a payment value associated with the purchase authorization request to a payment credit amount;
output for transmission, to the account host, an indication of a request to deduct the payment credit amount from the account credit amount;
output for transmission a payment authorization for the payment value; and
output for transmission, to the user device and after transmitting the payment authorization, an available balance of the virtual rewards card based on the account credit amount.

6. The system of claim 2, wherein the program code further instructs the at least one processor to:
receive a return notification for the virtual rewards account;
determine a return credit amount based on a return value associated with the return notification;
output for transmission, to the account host, an indication of a request to add the return credit amount from the account credit amount; and
output for transmission, to the user device, the available balance of the virtual rewards card based on the return credit amount.

7. The system of claim 6, wherein the return notification corresponds to a previous purchase authorization, and the program code further instructs the at least one processor to determine the return value by:
determining a payment credit amount associated with the previous purchase; and
setting the return credit amount based on the payment credit amount.

8. The system of claim 2, wherein the one or more conversion rules comprises a location based rule, and the program code further instructs the at least one processor to:
receive, from the user device, an indication of a current location of the user device; and
retrieve the account credit amount associated with the user account in response to receiving the indication of the current location.

9. The system of claim 2, wherein the program code further instructs the at least one processor to:
receive, from the user device, a request for a current value of the virtual rewards account, and
retrieve the account credit amount associated with the user account in response to receiving the request for the current value.

10. A method comprising:
retrieving, by at least one processor and from an account host, an account credit amount associated with a user account;
converting the credit amount to a monetary value based on one or more conversion rules associated with the account host; and
providing, by the at least one processor, an available balance of a virtual rewards account to correspond to the monetary value.

11. The method of claim 10, wherein a user device hosts a virtual rewards card corresponding to the virtual rewards account, and the method further comprises:
outputting for transmission, to the user device, the available balance.

12. The method of claim 11, further comprising:
updating the available balance of the virtual rewards account in substantially real-time to changes in the monetary value; and
outputting for transmission, to the user device in substantial real-time, the update to the available balance.

13. The method of claim 12, wherein the changes in the monetary value occur based on at least one of changes to an account credit amount associated with the user account or changes to conditions corresponding to the one or more conversion rules.

14. The method of claim 11 further comprising:
receiving, by the at least one processor, a purchase authorization request for the virtual rewards account;
converting, based on the one or more conversion rules, a payment value associated with the purchase authorization request to a payment credit amount;
outputting for transmission, by the at least one processor and to the account host, an indication of a request to deduct the payment credit amount from the account credit amount;
outputting for transmission, by the at least one processor, a payment authorization for the payment value; and
outputting for transmission, to the user device and after transmitting the payment authorization, an available balance of the virtual rewards card based on the account credit amount.

15. The method of claim 11 further comprising:
receiving a return notification for the credit rewards account;
determining a return credit amount based on a return value associated with the return notification;
outputting for transmission, by the at least one processor and to the account host, an indication of a request to add the return credit amount from the account credit amount; and
outputting for transmission, to the user device, the available balance of the virtual rewards card based on the return credit amount.

16. The method of claim 15, wherein the return notification corresponds to a previous purchase authorization, and the method further comprises:
determining a payment credit amount associated with the previous purchase; and
setting the return credit amount based on the payment credit amount.

17. The method of claim 11, wherein the one or more conversion rules comprises a location based rule, and the method further comprises:
receiving, from the user device, an indication of a current location of the user device; and
retrieving the account credit amount associated with the user account in response to receiving the indication of the current location.

18. The method of claim 11 further comprising:
receiving, from the user device, a request for a current value of the virtual rewards account, and
retrieving the account credit amount associated with the user account in response to receiving the request for the current value.

19. A method comprising:
receiving, by at least one processor, a purchase authorization request to utilize a credit rewards account, the credit rewards account being associated with one or more user accounts;
converting, by the processor and based on the one or more user accounts, a payment value to non-monetary credits to generate a payment credit amount;
deducting the payment credit amount from a credit amount of the one or more user accounts;
outputting for transmission, by the processor and in response to the deducting, a payment authorization for the payment value; and
updating the virtual rewards account to reflect an available account balance of the one or more user accounts following the deducting.

20. The method of claim 19, wherein the virtual rewards account is associated with a plurality of user accounts, and the method further comprises:
determining respective credit amounts for each of the plurality of user accounts;
converting the payment values to one or more separate payment credit amounts based on respective conversion rules of the plurality of user accounts; and
deducting one or more separate payment credit amounts from one or more of the plurality of user accounts.
